(19) United States
(12) Patent Application Publication
(10) Pub. No.: US 2009/0013904 A1
(43) Pub. Date: Jan. 15, 2009

(54) Method for manufacturing a solid plating material and the solid plating material manufactured by the method

(76) Inventors: Wataru Hisada, Aichi (JP); Kenji Tamaki, Aichi (JP)

Correspondence Address: BROMBERG & SUNSTEIN LLP, 125 SUMMER STREET, BOSTON, MA, 02110-1618, US

(21) Appl. No.: 10/579,198

(22) PCT Filed: Oct. 22, 2004
(86) PCT No.: PCT/JP2004/015684

§ 371 Date: Dec. 8, 2006

(30) Foreign Application Priority Data
Nov. 12, 2003 (JP) 2003-382435

(51) Int. Cl. B01J 13/20

(52) U.S. Cl. 106/287.18; 427/213.31

(57) ABSTRACT

This invention provides a method for manufacturing a solid plating material which has excellent electrical conductivity and durability, and the solid plating materials manufactured by this method, wherein

a suspension liquid is made by mixing a fluid for coating that includes an organic binder, with a powder for plating having electrical conductivity and a metal powder to be used for binding, wherein then

layers having the plating powder and the metal powder, and bound to the surfaces of core particles with the organic binder, are formed by means of injecting the suspension liquid on the surfaces of the core particles while the core particles are being agitated by centrifugal fluidization, and wherein

then the core particles are heated until their temperature is above the melting temperature of the metal powder to be used for binding so as to remove the organic binder and to form deposited layers of the plating powder by melting the metal powder to be used for binding.

If a powder having excellent electrical conductivity is used as the plating powder, solid plating materials having excellent electrical conductivity and durability can be manufactured.

### TECHNICAL FIELD

This invention relates to a method for manufacturing a solid plating material and the solid plating material manufactured by the method, which is used to form coated films on products such as separators of a variety of fuel cells for automobiles, stationary power sources, or mobile power sources, the markets for which products are sufficiently large and growing. Especially, the coated films are formed by blasting and have an excellent electrical conductivity.

### BACKGROUND OF THE INVENTION

As a method for forming coated films on the surfaces of products to modify the surfaces, there is plating, such as electroplating, hot-dip plating, diffusion plating, or vapour-deposition plating, and fusion for forming coated films on the surfaces of products by injecting heated and molten metal powder. These methods for forming the coated films need expensive facilities, because the facilities used for the methods are large. Further, it is a problem of these methods in that if the materials of the coated films are nonmetal, such as oxidative products, these methods cannot be used for forming the coated films on the surfaces of the products.

To solve those problems, the inventors in this application developed a method for blasting to form coated films on the surfaces of products, instead of plating or fusion. They also developed a solid plating material for the blasting process. These are disclosed in Patent Documents 1, 2, and 3, which were published prior to the fling of this application.

Patent Document 1 discloses a solid plating material. The solid plating material is made from a central particle (hereafter “a core particle”) coated by plating. The core particle has a diameter of 30-300 μm and a hardness of 400-2000 Hv, and is made from a hard metal alloy. The core particle is plated with a metal powder (hereafter at “plating powder”), such as gold, silver, copper, or nickel, which has an excellent electrical conductivity (lower electrical resistance). Patent Document 1 indicates that there are gold, silver, etc., which are more expensive, as a plating powder having an excellent electrical conductivity.

Patent Document 2 discloses a method for forming coated films on the surfaces of separators of fuel cells. These coated films have an excellent electrical conductivity (lower electrical resistance) and are formed by blasting solid plating materials with a flow of dry air, impellers, a high pressure flow of water, or a flow of inert gas.

Patent Document 3 discloses a method for manufacturing a solid plating material and the solid plating material manufactured by the method. This solid plating material is manufactured by the following steps: First, coated layers are formed on the surfaces of core particles having a diameter of less than 2 mm, and being made from steel, a non-ferrous metal, a non-ferrous alloy, or a nonmetal material, by injecting a coating fluid that includes an organic binder. Second, a suspension liquid is prepared by mixing the coating fluid with inorganic powder, as a plating powder, having a diameter of less than 0.5 mm, and being made from zinc, copper (base metal), gold, silver (precious metal), or an oxidative product (nonmetal). Lastly, the surfaces of the coated layers of the core particles are plated with the plating powder by injecting the suspension liquid on the surfaces.
Patent Document 1: Japanese Patent Publication Laid-open No. 2001-089870
Patent Document 2: Japanese Patent Gazette No. 3468739 (U.S. Pat. No. 6,726,953)
Patent Document 3: Japanese Patent Publication Laid-open No. 2003-160884

### DISCLOSURE OF INVENTION

The methods for manufacturing a solid plating material that are used for blasting in order to form coated films having improved electrical conductivity, and that are disclosed in Patent Documents 1 and 3, have the following problems.

Namely, the method disclosed in Patent Document 1 discloses a plating technology. Thus, since it needs large facilities, there is a problem in that the costs of the plant used for the method for manufacturing a solid plating material increase.

Since the method disclosed in Patent Document 3 does not use plating technology, it does not have the same problem as does the method disclosed in Patent Document 1. However, when coated films are formed on the surfaces of products by blasting solid plating materials in order to form coated films having excellent electrical conductivity, which solid plating materials are manufactured by the method disclosed in Patent Document 3, it becomes a problem in that no coated films having an adequate high electrical conductivity can be formed.

The reason for this problem is as follows: Since the coated layer of the solid plating material includes the plating powder and the organic binder, the coated films formed on the surfaces of the products also include both the plating powder and the organic binder. This organic binder is used to increase the bonding strength between the coated films and the plating powder and to improve the durability of the solid plating materials. However, since the organic binder is a nonconductive material, the electrical resistance, such as surface resistance or contact resistance, of the coated layer plated with the solid plating material, increases.

As stated in the above paragraph, when it is required to form a coated film having excellent electrical conductivity, it is not proper to use the solid plating materials which are manufactured by the method disclosed in Patent Document 3. The contents of the plating powder and the organic binder in the coated layer affect the electrical conductivity and the durability of the solid plating materials (the bonding strength between the coated layer and the plating powder), which durability is required so that the solid plating materials can be repeatedly used. Thus, by the method for manufacturing the solid plating materials disclosed in Patent Document 3, since there is a conflict between the electrical conductivity of the coated layer and the durability of the solid plating materials, it is difficult to manufacture solid plating materials having both excellent electrical conductivity and excellent durability.

This invention solves these problems. Namely, this invention provides a method for manufacturing a solid plating material having both excellent electrical conductivity and excellent durability, and the solid plating materials manufactured by the method.

The method for manufacturing a solid plating material of this invention is comprised of:

a step for preparing a suspension liquid made by mixing a coating fluid which includes an organic binder, a plating powder having electrical conductivity, and a metal powder to be used for binding,

a step for forming coated layers that include the plating powder and the metal powder, and which are bound to surfaces of core particles with the organic binder by means of injecting the suspension liquid on the surfaces of the core particles while the core particles are being agitated by centrifugal fluidization, and

a step for heating the core particles above the melting temperature of the metal powder to be used for binding to remove the organic binder and to form deposited layers of the plating powder by melting the metal powder.

In the invention stated in the above paragraph, by means of injecting the suspension liquid onto the surfaces of the core particles while beating the core particles from 30-70° C., solid plating materials having coated layers which have more excellent electrical conductivity and durability can be manufactured.

It is preferable to control the flow rate of the suspension liquid to inject it onto the core particles so that it becomes 0.5-2 g/min.

Further, it is preferable that the coating fluid consist of water or a mixture of water and alcohol which contains 4% by mass of the organic binder.

It is preferable that the plating powder consist of powder of an electrical conductive ceramic having an average diameter of lees than 20 μm. Further, it is preferable that the melting temperature of the metal powder to be used for binding be lower than that of the core particles, and that the average diameter of the metal powder to be used for binding be less than 20 μm.

It is more preferable that the average diameter of the core particles be less than 2 mm. Particles made from a hard metal alloy, steel, nonferrous metal, or a nonmetallic inorganic substance can be used as the core particles.

In the process for heating the core particles after forming the coated layers, when the melting temperature of the metal powder to be used for binding is greater than or equal to 350° C., or it is 50° C. or more of the starting temperature of the oxidization of the plating powder, it is preferable that the core particles be heat-treated in a non-oxidative atmosphere. In contrast, when the melting temperature of the metal powders to be used for binding is less than 350° C., or it is less than 50° C. below the starting temperature of the oxidization of the plating powder, it is preferable that the core particles be heat-treated in air.

It is preferable that the solid plating materials be manufactured so that the percentage of the plating powder to the core particles becomes less than 5% by mass, and that the percentage of the metal powder to be used for binding the core particles becomes less than 3% by mass.

The solid plating materials of this invention are manufactured by means of the method explained above.

The method for manufacturing the solid plating materials of this invention is comprised of a step for forming the coated layers. These layers include the plating powder and the metal powder. The coated layers are bound to the surfaces of the core particles with the organic binder. It is further comprised of a step for heating the core particles until they are above the melting temperature of the metal powder to be used for binding, as a final heat treatment, to pyrolytically decompose the organic binder and to remove it. Then the deposited layers, which include the plating powder, are formed on the surfaces of the core particles by means of melting the metal powder to be used for binding. Consequently, deposited layers having excellent durability can be formed. If the metal powder having electrical conductivity is used as the plating powder, solid plating material which can form non-oxygenated coated films having excellent electrical conductivity on the surfaces of the products can be manufactured.

### PREFERRED EMBODIMENTS OF THE INVENTION

Below, the preferred embodiments of the invention are explained.

Prior to manufacturing the solid plating material of this invention, a suspension liquid is prepared by mixing a coating fluid that includes an organic binder with a plating powder and a metal powder to be used for binding.

Next, coated layers are formed by means of injecting the suspension liquid on the surfaces of core particles while the core particles are being agitated by centrifugal fluidization and are heated to a predetermined temperature. The coated layers include the plating powder and the metal powder, which layers are bound to the surfaces of the core particles with the organic binder.

Then, after forming the coated layers on the surfaces of the core particles, the core particles are heated to above the melting temperature of the metal powder to be used for binding. Consequently, the organic binder is pyrolytically decomposed and removed from the coated layers, and the metal powder to be used for binding is melted. The melted metal powder to be used for binding can also firmly bind the plating powder to the coated layers.

In the method for manufacturing the solid plating material explained above, as the coating fluid, water, or a mixture of water and alcohol which includes a vinyl or an acrylate organic binder, can be used. The concentration of the organic binder must be within a predetermined scope so that the organic binder can be uniformly injected. Generally, since the viscosity of the organic binder is proportional to the concentration of it, it is preferable to set the concentration of the organic binder to be less than 4% in order to avoid a nonuniform injection.

As the organic binder, PVA (polyvinyl alcohol), modified PVA, PVP (polyvinylpyrrolidone), and a methacrylic acid copolymer can be used.

As the plating powder, nonoxide ceramics having electrical conductivity, such as TiN, TiC, VC, NbC, or MoSi₂, can be used. It is preferable that the average diameter of the plating powder be less than 20 μm.

In addition to gold or silver, copper or tin, which are cheaper than gold and silver, can be used as the metal powder to be used for binding. The melting temperature of the metal powder to be used for binding must be less than that of the core particles. Further, it is preferable that the average diameter of the metal powder be less than 20 μm.

The reason that it is preferable that the average diameters of the plating powder and the metal powder to be used for binding be less than 20 μm is as follows: If the average diameters of the plating powder and the metal powder to be used for binding are greater than 20 μm, it becomes difficult to form the uniform coated layers on the surfaces of the core particles.

Particles of a hard metal alloy, particles of steel, such as high speed steel or carbon steel, particles of a nonferrous metal, such as copper, or particles of a nonmetallic inorganic substance, such as glass beads or aluminum oxide, can be used as the core particles. It is more preferable that the average diameter of the core particles be less than 2 mm. The reason that it is more preferable that the average diameter of the core particles be less than 2 mm is as follows: If the average diameters of the core particles are greater than 2 mm, the surfaces of the products which are blasted become rough, and the deformations of the products are increased.

When the suspension liquid is injected from a nozzle, it is preferable that the core particles be agitated by centrifugal fluidization and heating until a temperature of 30-70° C. is reached. If the core particles are heated below 30° C., it would be hard for a solvent, such as water, in the coating liquid, to escape as vapor, and it would take a long time to dry the coated layers. In contrast, if the core particles are heated to above 70° C., the solvent would quickly escape as vapor; however, then, when the coating liquid is injected, a nonuniform binding on the surfaces of the core particles of the plating powder, the metal powder to be used for binding, and the organic binder, which is a substance dissolved in the coating liquid, is caused.

It is preferable that the flow rate of the suspension liquid be controlled so that it is injected onto the surfaces of the core particles at 0.5-2 g/min. If the flow rate of the suspension liquid is less than 0.5 g/min, it would take a long time to inject it. In contrast, if the flow rate of the suspension liquid is more than 2 g/min, a nonuniform binding of the substance dissolved in the coating liquid would be caused.

In the final process for heating the core particles after forming the coated layers, when the melting temperature of the metal powder to be used for binding is 350° C. or more, or it is 50° C. or more below the starting temperature of the oxidization of the plating powder, it is preferable that the core particles be heat-treated in a non-oxidative atmosphere, such as nitrogen gas or argon gas. For forming the coated layers having electrical conductivity, if the core particles are heat-treated in an oxidative atmosphere, such as air, since a ceramic having an electrical conductivity, which is used as the plating powder, is oxidized, the electrical resistance of the coated layers bound to the surfaces of the core particles increases. Consequently, a coating having a lower electrical conductivity may be formed on the surfaces of the products. In contrast, when the melting temperature of the metal powder to be used for binding is less than 350° C., or it is less than 50° C. below the starting temperature for the oxidization of the plating powder, the core particles may be heat-treated in air.

In the method for manufacturing the solid plating material stated above, it is preferable to control the percentage of the plating powder to the core particles so that it becomes less than 5% by mass, and so that the percentage of the metal powder to be used for binding to the core particles becomes less than 3% by mass.

If the percentage of the plating powder to the core particles becomes more than 5% by mass, and the percentage of the metal powder to be used for binding to the core particles becomes more than 3% by mass, since the quantity of the plating powder having the electrical conductivity and the metal powder to be used for binding would become too great, the suspension liquid would become nonuniform, and it would become hard to inject the suspension liquid onto the surfaces of the core particles.

### Embodiments 1 and 2

Based on Table 1, embodiments 1 and 2 of this invention, which use titanium nitride as the plating powder and copper as the metal powder to be used for binding, and comparative examples 1 and 2, are explained below.

### [Table 1]

TABLE 1

| | Items | | | |
|---|---|---|---|---|
| | | | Comparative | Comparative |
| | Embodiment 1 | Embodiment 2 | Example 1 | Example 2 |
| A Core Particle | Hard metal alloy | Hard metal alloy | Hard metal alloy | Hard metal alloy |
| Content of Organic Binder (% by mass) | 3 | 3 | 3 | 3 |
| Content of Titanium Nitride (% by mass) | 4.4 | 4.4 | 5.6 | 5.6 |
| Content of Powder of Copper (% by mass) | 1.9 | 1.9 | 0 | 0 |
| Temperature of the Core Particles when Injecting | 59 | 79 | 80 | 59 |
| Suspension Liquid (° C.) | | | | |
| Atmosphere in the Furnace | Nitrogen Gas | Nitrogen Gas | Nitrogen Gas | Nitrogen Gas |
| Temperature in the Furnace (° C.) | 1,100 | 1,100 | 1,100 | 1,100 |
| Number of Reuses of the Solid Plating Material | 80 | 50 | 28 | 32 |
| Contact Resistance (mΩ · cm²) | 3.8 | 3.9 | 4.3 | 4.0 |
| Durability of the Coating Layers | Excellent | Good | Poor | Poor |

In embodiment 1, preliminarily the suspension liquid is prepared as follows: 70 g of powder of titanium nitride having an average diameter of 7 μm is added and mixed with 320 g of a PVA solution having a 3% concentration by mass so that the final percentage of the powder of the titanium nitride to 1.6 Kg of the core particles becomes 4.4% by mass. Then, 30 g of powder of copper having an average diameter of 10 μm as the metal powder to be used for binding (binder) is added and mixed with the PVA solution so that the final percentage of the powder of the copper to the core particles becomes 1.9% by mass.

Next, 1.6 Kg of the core particles made from a hard metal alloy and having an average diameter of 100 μm is put in a coating machine, and the suspension liquid is injected onto the surfaces of the core particles from a nozzle having a diameter of 0.7 mm with an injection pressure of 0.15 MPa and a flow rate of 1.7 g/min. while the core particles are being heated to 59° C. and are being agitated by centrifugal fluidization at 130 rev./min. Consequently, the core particles coated with the powder of the titanium nitride and the powder of the copper on the surfaces of them are formed.

The core particles are put in a furnace that is filled with nitrogen gas, and then the core particles in the furnace are heated to 1100° C. for one hour. Consequently, all the PVA is removed, and the solid plating materials, which have coated layers that are not oxidized and that include the powder of the titanium nitride uniformly dispersed in the layers by melting the powder of the copper, can be manufactured.

The reason that at the final heat treatment the furnace is filled with nitrogen gas, and the temperature of the furnace is raised to 1100° C. (heating period is one hour), is as follows: These conditions are determined based on the relationships stated in claim 8 and the facts that the starting temperature of the oxidization of the plating powder (the titanium nitride) is 550-560° C., and the melting temperature of the metal powder to be used for binding (the copper) is 1,083° C.

Next, 800 g of the solid plating materials manufactured as in embodiment 1 stated above is put in an apparatus for air-blasting. Then, a test piece with a diameter of 30 mm and 4 mm thick and made from stainless steel SUS316 is fixed in the apparatus. Then the solid plating materials are injected on the entire surface of the test piece under the following conditions: the distance between the test piece and the nozzle: 100 mm; the angle between the center line of the nozzle and the surface of the test piece: 90 degrees, the pressure of the injection: 0.3 MPa; period of the injection: 18 seconds.

Thus, a coated film of titanium nitride, which is not oxidized, can be formed on the surface of the test piece.

By measuring the contact resistance between the surface of the test piece and the carbon probe, it was found that the resistance is 3.8 mΩ·cm², and thus is very low. The contact resistance between the carbon probe and the surface of the stainless steel before forming the coated film by blasting the solid plating materials of this invention is 500-600 mΩ·cm².

A durability test to evaluate the durability of the coated layers of the solid plating materials manufactured as in embodiment 1 was conducted by means of using the apparatus for air-blasting and a target sample made from steel SS400, and repeatedly blasting the solid plating materials onto the target sample. Consequently, it was found that the solid plating materials have excellent durability. Namely, the number of times that the solid plating materials could be used again, which is defined as the number of blasts until 50% of the plated layers are broken away, is 80.

In embodiment 2, the solid plating materials are manufactured by the same method as in embodiment 1, except that when the suspension liquid is injected, the core particles are heated until the temperature reaches 79° C. The result of measuring the contact resistance between the coated surface of the test piece and the carbon probe almost equals the result of embodiment 1. This indicates that the coated surface has excellent contact resistance. Further, in the durability test, the number of times that the solid plating materials can be reused, which is defined as a number of blasts until 50% of the plating layers are broken away, cannot reach 80. The number of times that the solid plating materials of embodiment 2 can be reused is 50. It was found that the solid plating materials still have good durability. Hence, the method for measuring the contact resistance and the method for evaluating the durability are the same as those of embodiment 1.

Next, comparative examples 1 and 2 are explained. In comparative example 1, the solid plating material is manufactured without using any metal powder to be used for binding. In the manufacturing process, when the suspension liquid is injected onto the surfaces of the core particles, the core particles are heated to 80° C., which is near the temperature of embodiment 2. In comparative example 2, the solid plating materials are manufactured without using any metal powder to be used for binding. Further, in the manufacturing process of comparative example 2, when the suspension liquid is injected onto the surfaces of the core particles, the core particles are heated to 59° C., as in embodiment 1. Table 1 shows the contact resistance between the coated surface of the test piece and the carbon probe. That table indicates the electrical conductivity of the coated layers, and the results of the durability tests of the coated layers of the solid plating materials of comparative examples 1 and 2. Hence, the method for measuring the contact resistance and the method for evaluating the durability are also the same as those of embodiments 1 and 2.

For the results showing the contact resistance between the coated surface of the test piece and the carbon probe, since the difference between the contact resistance of comparative examples 1 and 2 and that of embodiment 1 is within about 10%, it was found that the test piece has excellent electrical conductivity. The reason for this is that electrically conductive coated layers that are not oxidized are formed because the plating powder (the titanium nitride) used in comparative examples 1 and 2 is the same as that of embodiment 1, and because at the final heat treatment the furnace is filled with nitrogen gas, and the temperature of the furnace is raised to 1100° C., as in embodiment 1.

However, from the results of the test to evaluate the durability of the coated layers formed on the surfaces of the core particles, it is seen that the results of comparative examples 1 and 2 are significantly inferior to those of embodiments 1 and 2. This is because in comparative examples 1 and 2, the coated layers bound to the surfaces of the particles are brittle, because no metal powder to be used for binding is included. Thus, the result of the test to evaluate the durability of the coated layers shows no advantage.

### Embodiment 3

Table 2 shows embodiment 3 of this invention. In embodiment 3, titanium nitride is used as the plating powder, and tin is used as the metal powder to be used for binding.

TABLE 2

| | Items |
|---|---|
| | Embodiment 3 |
| A Core Particle | Hard metal alloy |
| Content of Organic Binder (% by mass) | 3 |
| Content of Titanium Nitride (% by mass) | 4.2 |
| Content of Powder of Tin (% by mass) | 1.8 |
| Temperature of the Core Particles when Injecting | 64 |
| Suspension Liquid (° C.) | |
| Atmosphere in the Furnace | Air |
| Temperature in the Furnace (° C.) | 250 |
| Number of Reuses of the Solid Plating Material | 65 |
| Contact Resistance (mΩ · cm²) | 7.5 |
| Durability of the Coating Layer | Good |

In embodiment 3, preliminarily the suspension liquid is prepared as follows: 67 g of powder of titanium nitride having an average diameter of 7 μm is added and mixed with 320 g of a PVA solution having a 3% concentration by mass so that the final percentage of the powder of titanium nitride to 1.6 Kg of the core particles becomes 4.2% by mass. Then, 29 g of powder of tin having an average diameter of 10 μm as a metal powder to be used for binding (binder) is added and mixed with the PVA solution so that the final percentage of the powder of the tin to the core particles becomes 1.8% by mass.

Next, 1.6 Kg of the core particles made from a hard metal alloy and having an average diameter of 100 μm is put in a coating machine, and the suspension liquid is injected onto the surfaces of the core particles from a nozzle having a diameter of 0.7 mm with an injection pressure of 0.15 MPa and a flow rate of 1.7 g/min. while the core particles are being heated to 64° C. and are agitated by centrifugal fluidization at 130 rev./min. Consequently, core particles coated with the powder of the titanium nitride and the powder of the tin on the surfaces of them are formed.

The core particles are put in a furnace that is filled with air. Then the core particles in the furnace are heated to 250° C. for two hours. Consequently, all the PVA is removed. Thus solid plating materials that have coated layers that are not oxidized and that include powder of titanium nitride uniformly dispersed in the layer by melting the powder of the tin can be manufactured.

The reason that at the final heat treatment the furnace is filled with air, and the temperature of the furnace is raised to 250° C. (heating period is two hours), is as follows: These conditions are determined based on the relationships as in claim 8 and the facts that the starting temperature of the oxidization of the plating powder (the titanium nitride) is 550-560° C., and the melting temperature of the metal powder to be used for binding (the tin) is 232° C.

Next, 800 g of the solid plating materials manufactured as in embodiment 3 stated above is put in an apparatus for air-blasting. Then, under the same conditions as in embodiment 1, such as the test piece used to form a coated film, the distance between the test piece and the nozzle, the angle between the center line of the nozzle and the surface of the test piece, the pressure of the injection, and the period of the injection, the solid plating materials are injected onto the entire surface of the test piece. Consequently, a coated film of titanium nitride, which is not oxidized, can be formed on the surface of the test piece.

By measuring the contact resistance between the surface of the test piece and the carbon probe, it was found that the resistance is 7.5 mΩ·cm², and thus is very low.

A durability test to evaluate the durability of the coated layers of the solid plating materials manufactured as in embodiment 3 was conducted by means of using the apparatus for air-blasting and a target sample made from steel SS400, and repeatedly blasting the solid plating materials onto the target sample. Consequently, it was found that the solid plating materials have good durability. Namely, the number of times that the solid plating materials can be reused, which is defined as a number of blasts until 50% of the plating layers is broken away, was 65.

### Embodiment 4

Table 3 shows embodiment 4 of this invention. In embodiment 4, vanadium carbide is used as the plating powder, and copper is used as the metal powder to be used for binding.

TABLE 3

| | Items |
|---|---|
| | Embodiment 4 |
| A Core Particle | Hard metal alloy |
| Content of Organic Binder (% by mass) | 3 |
| Content of Vanadium Carbide (% by mass) | 4.4 |
| Content of Powder of Copper (% by mass) | 1.9 |
| Temperature of the Core Particles when Injecting | 64 |
| Suspension Liquid (° C.) | |
| Atmosphere in the Furnace | Nitrogen Gas |
| Temperature in the Furnace (° C.) | 1,100 |
| Number of Reuses of the Solid Plating Material | 92 |
| Contact Resistance (mΩ · cm²) | 3.3 |
| Durability of the Coating Layers | Excellent |

In embodiment 4, preliminarily the suspension liquid is prepared as follows: 70 g of powder of vanadium carbide having an average diameter of 1.8 μm is added and mixed with 320 g of a PVA solution having a 3% concentration by mass so that the final percentage of the powder of the vanadium carbide to 1.6 Kg of the core particles becomes 4.4% by mass. Then, 30 g of powder of copper having an average diameter of 10 μm, used as a metal powder to be used for binding (binder), is added and mixed with the PVA solution so that the final percentage of the powder of the copper to the core particles becomes 1.9% by mass.

Next, 1.6 Kg of the core particles made from a hard metal alloy and having average diameter of 100 μm was put in a coating machine, and the suspension liquid was injected onto the surfaces of the core particles from a nozzle having a diameter of 0.7 mm with an injection pressure of 0.15 MPa and a flow rate of 1.7 g/min. while the core particles were heated to 64° C. and were agitated by centrifugal fluidization at 130 rev./min. Consequently, core particles coated with the powder of the vanadium carbide and the powder of the copper on the surfaces of them were formed.

The core particles were put in a furnace that was filled with nitrogen gas. Then the core particles in the furnace were heated to 1100° C. for one hour. Consequently, all the PVA was removed. Thus, solid plating materials that have coated layers that are not oxidized and that include powder of vanadium carbide uniformly dispersed in the layers by melting the powder of the copper, can be manufactured.

The reason that at the final heat treatment the furnace is filled with nitrogen gas and the temperature of the furnace is raised to 1100° C. (a heating period of one hour) is as follows: These conditions are determined based on the relationships stated in claim 8 and the facts that the starting temperature of the oxidization of the plating powder (the vanadium carbide) is 440-450° C., and the melting temperature of the metal powder to be used for binding (the copper) is 1,083° C.

Next, 800 g of the solid plating materials manufactured as in embodiment 4 stated above was put in an apparatus for air-blasting. Then, under the same conditions as in embodiment 1, such as the test piece to form a coated film, the distance between the test piece and the nozzle, the angle between the center line of the nozzle and the surface of the test piece, the pressure of the injection, and the period for injection, the solid plating materials were injected onto the entire surface of the test piece. Consequently, a coated film of vanadium carbide, which is not oxidized, can be formed on the surface of the test piece.

By measuring the contact resistance between the surface of the test piece and the carbon probe, it was found that the resistance is 3.3 mΩcm², and thus is very low.

A durability test to evaluate the durability of the coated layers of the solid plating materials manufactured as in embodiment 4 was conducted by means of using the apparatus for air-blasting and a target sample made from steel SS400, and repeatedly blasting the solid plating materials onto the target sample. Consequently, it was found that the solid plating materials have excellent durability. Namely, the number of times that the solid plating materials can be reused, which is defined as the number of blasts until 50% of the plating layers is broken away, is 92.

### Embodiment 5

Table 4 shows embodiment 5 of this invention. In embodiment 5, vanadium carbide is used as the plating powder, and tin is used as the metal powder to be used for binding.

TABLE 4

| | Items |
|---|---|
| | Embodiment |
| A Core Particle | Hard metal alloy |
| Content of Organic Binder (% by mass) | 3 |
| Content of Vanadium Carbide (% by mass) | 4.2 |
| Content of Powder of Tin (% by mass) | 1.8 |
| Temperature of the Core Particles when Injecting | 64 |
| Suspension Liquid (° C.) | |
| Atmosphere in the Furnace | Air |
| Temperature in the Furnace (° C.) | 250 |
| Number of Reuses of the Solid Plating Material | 68 |
| Contact Resistance (mΩ · cm²) | 8.4 |
| Durability of the Coating Layers | Good |

In embodiment 5, preliminarily the suspension liquid is prepared as follows: 67 g of powder of vanadium carbide having an average diameter of 1.8 μm is added and mixed with 320 g of a PVA solution having a 3% concentration by mass so that the final percentage of powder of the vanadium carbide to 1.6 Kg of the core particles becomes 4.2% by mass. Then, 29 g of powder of tin having an average diameter of 10 μm, as a metal powder to be used for binding (binder), was added and mixed with the PVA solution. Thus, the final percentage of the powder of the tin to the core particles became 1.8% by mass.

Next, 1.6 Kg of core particles made from a hard metal alloy and having an average diameter of 100 μm was put in a coating machine. Then the suspension liquid was injected onto the surfaces of the core particles from a nozzle having a diameter of 0.7 mm with an injection pressure of 0.15 MPa and a flow rate of 1.7 g/min. while the core particles were heated to 64° C. and were agitated by centrifugal fluidization at 130 rev./min. Thus, core particles coated with the powder of vanadium carbide and the powder of tin on the surfaces of them were formed.

The core particles were put in a furnace that was filled with air. Then the core particles in the furnace were heated to 250° C. for three hours. Consequently, all the PVA was removed. Thus, solid plating materials that have coated layers with a uniform distribution of powder of vanadium carbide, which is caused by melting the powder of the tin and that is not oxidized, can be manufactured.

The reason that at the final heat treatment the furnace was filled with air and the temperature of the furnace was raised to 250° C. (heating period was three hours), is as follows. These conditions were determined based on the relationships stated in claim 8 and the facts that the starting temperature of the oxidization of the plating powder (the vanadium carbide) was 440-450° C., and the melting temperature of the metal powder to be used for binding (the tin) was 232° C.

Next, 800 g of the solid plating material manufactured as in embodiment 5 above was put in an apparatus for air-blasting. Then, under the same conditions as in embodiment 1, such as a test piece to form a coated film, the distance between the test piece and the nozzle, the angle between the center line of the nozzle and the surface of the test piece, the pressure of the injection, and the period for injection, the solid plating materials were injected onto the entire surface of the test piece. Consequently, a coated film of vanadium carbide that is not oxidized was able to be formed on the surface of the test piece.

By measuring the contact resistance between the surface of the test piece and carbon probe, it was found that the resistance is 8.4 mΩ·cm², and is thus very low.

A durability test to evaluate the durability of the coated layers of the solid plating materials manufactured as in embodiment 5 was conducted by means of using an apparatus for air-blasting and a target sample made from steel SS400, and repeatedly blasting the solid plating materials at the target sample. Consequently, it was found that solid plating materials have good durability. Namely, the number of times that the solid plating materials can be reused, which is defined as a number of blasts until 50% of the plating layers is broken away, is 68.

1. A method for manufacturing solid plating materials, comprising:
a step for preparing a suspension liquid by mixing plating powder having electrical conductivity and a metal powder to be used for binding with a coating fluid which includes an organic binder,
a step for forming layers on surfaces of core particles, which layers include the plating powder and the metal powder to be used for binding, wherein the plating powder and the metal powder are bound to the surfaces of the core particles by the organic binder, by means of injecting the suspension liquid onto the surfaces of the core particles while the core particles are being agitated by centrifugal fluidization, and
a step for removing the organic binder and forming the coated layers bound to the surfaces by melting the metal powder, which layers include the plating powder, by means of heating the core particles until the temperature is above the melting temperature of the metal powder.

2. The method of claim 1, wherein in the step for forming the layers the suspension liquid is injected onto the surfaces of the core particles while the core particles are being further heated to 30-70° C.

3. The method of claim 1, wherein in the step for forming the layers the suspension liquid is injected onto the surfaces of the core particles with a flow rate of 0.5-2 g/min.

4. The method of claim 1, wherein in coating fluid is comprised of water or a mixture of water and alcohol that includes less than 4% by mass of the organic binder.

5. The method of claim 1, wherein the plating powder consists of powder of an electrically conductive ceramic having an average diameter of less than 20 μm.

6. The method of claim 1, wherein the melting temperature of the metal powder to be used for binding is lower than that of the core particles, and wherein the average diameter of the particles of the metal powder is less than 20 μm.

7. The method of claim 1, wherein the average diameter of the core particles is less than 2 mm, and wherein the core particles are made from any of a hard metal alloy, steel, a nonferrous metal, or a nonmetallic inorganic substance.

8. The method of claim 1, wherein the core particles are heated based on the following conditions:
when the melting temperature of the metal powder to be used for binding is 350° C. or above or 50° C. or more below the starting temperature for the oxidization of the plating powder, the core particles are heat-treated in a non-oxidative atmosphere, and
when the melting temperature of the metal powder to be used for binding is less than 350° C. or is less than 50° C. below the starting temperature of the oxidization of the plating powder, the core particles are heat-treated in air.

9. The method of claim 1, wherein the percentage of the plating powder to the core particles is less than 5% by mass, and wherein the percentage of the metal powder to be used for binding the plating powder to the core particles is less than 3% by mass.

10. A solid plating material which is manufactured by the method of any of claims 1-9.
